(19) United States
(12) Patent Application Publication
(10) Pub. No.: US 2026/0359148 A1
(43) Pub. Date: Nov. 12, 2026

(54) APPARATUS FOR EVENT STREAM MANIPULATION

(71) Applicant: Kovilta Oy, Turku (FI)

(72) Inventors: Mika LAIHO, Vanlaa (FI); Ari PAASIO, Littoinen (FI); Eero LEHTONEN, Turku (FI)

(21) Appl. No.: 19/475,071

(22) PCT Filed: Apr. 12, 2024
(86) PCT No.: PCT/FI2024/000006

§ 371 Date: Oct. 14, 2025

(30) Foreign Application Priority Data
Apr. 13, 2023 (FI) 20237070

(51) Int. Cl. G06F 9/54

(52) U.S. Cl. CPC G06F 9/542

(57) ABSTRACT

It is an objective of the present invention to provide an event stream manipulation apparatus (100), In more detail, it is an objective of the invention to provide an event stream manipulation apparatus that generates event streams corresponding to slower timescales from an event stream. It is a further objective of the invention to provide an sensor event stream manipulation apparatus that can recursively produce multiple slower timescales (event time pyramid) from input event stream with little computing resources. Also, it is a further objective of the invention to provide a compact event stream manipulation system suitable for example on-sensor computing applications, comprising a plurality of event stream manipulation apparatuses and use the event stream manipulation system for signal processing such as image analysis, for example optical flow compute.

### TECHNICAL FIELD OF THE INVENTION

The present invention relates to an event stream manipulation apparatus according to the preamble of the appended independent claim. The invention also relates to an event stream manipulation system comprising a plurality of such apparatuses.

### BACKGROUND OF THE INVENTION

Neuromorphic processing with events has gained popularity since the introduction of event cameras and also event cochleas. The emphasis on the prior art of the event generating devices has been on asynchronous event generation although in reality the events' time instances are coded by digital time stamps resulting in discrete time representation. Although the asynchronously treated events have discrete time stamps, the scanning of the events still relies on asynchronous timing meaning that the scanning frequency of each individual event producing entity is not constant. It is very hardware consuming and difficult to determine with the asynchronously generated events, if a certain event pattern has occurred in the close neighboring event generating locations within a certain time window. The time stamps used in the prior art consist normally of 16 or more bits resulting in vast memory requirements for storing the time stamps of e.g. a megapixel camera in a pixel by pixel manner. It is the purpose of the described invention to remove the requirement for time stamping of events by using synchronously scanned events and producing representations for slower event scanning results from faster event scanning results. The formed event representations can directly be used for computation without searching any time stamps.

### OBJECTIVES OF THE INVENTION

It is the main objective of the present invention to reduce or even eliminate the prior art problems presented above.

It is an objective of the present invention to provide an event stream manipulation apparatus. In more detail, it is an objective of the invention to provide an event stream manipulation apparatus that generates event streams corresponding to slower timescales from an event stream. It is a further objective of the invention to provide an sensor event stream manipulation apparatus that can recursively produce multiple slower timescales (event time pyramid) from input event stream with little computing resources. Also, it is a further objective of the invention to provide a compact event stream manipulation system suitable for example on-sensor computing applications, comprising a plurality of event stream manipulation apparatuses and use the event stream manipulation system for signal processing such as image analysis, for example optical flow compute.

In order to realize the above-mentioned objectives, the event stream manipulation apparatus according to the invention is characterised by what is presented in the characterising portion of the appended independent claim. Advantageous embodiments of the invention are described in the dependent claims.

### SUMMARY OF THE INVENTION

According to a first aspect of the invention there is provided an event stream manipulation apparatus that comprises
Input event channel arranged to provide a first integer event signal corresponding to a time instant T_A and a second integer event signal corresponding to a time instant T_B,
a first digital memory arranged to receive and store the first integer event,
a summing circuit having a first summing input and a second summing input, wherein
the first summing input is arranged to receive the stored first integer event signal from the first digital memory,
the second summing input is arranged to receive second integer event signal from the input event channel,
and the summing circuit arranged to sum the stored first integer event signal with the second integer event signal and to produce a first summing result, wherein the first summing result is provided to the output of the summing circuit,
an event clamping circuit connected to the summing circuit and arranged to receive the summing result and to determine whether the summing result
   is above or equal to a positive threshold and in such case produce a first output event that equals the positive threshold,
   and to determine whether the summing result is below or equal to a negative threshold and in such case produce a first output event that equals the negative threshold,
   and to determine whether the summing result is below the positive threshold and above the negative threshold and in such case produce a first output event that equals the summing result,
wherein the first output event corresponding to time instant T_B is arranged to the output event channel at the output of the event stream apparatus.

According to an embodiment of the invention the event stream manipulation apparatus comprises:
an event preprocessing circuit arranged to receive at least one raw input event signal from raw input event channel and arranged to provide an output signal that is a function of at least one raw input event signal, wherein the output signal of the event preprocessing circuit is arranged to the input event channel.

According to an embodiment of the invention the event stream manipulation apparatus comprises:
a first multiplexer having a first multiplexer input and a second multiplexer input and a first multiplexer output, the first multiplexer arranged to provide either the first multiplexer input or the second multiplexer input to the first multiplexer output, wherein
the first multiplexer input is arranged to receive signal from the input event channel,
the second multiplexer input is arranged to receive signal from a second digital memory,
the first multiplexer output is provided to the first digital memory and the second summing input of the summing circuit,
a second digital memory with at least two memory locations arranged to receive and store a signal from the output event channel and arranged to provide an output signal to the second multiplexer input.

According to an embodiment of the invention the event stream manipulation apparatus comprises:
a second multiplexer having a third multiplexer input and a fourth multiplexer input and a second multiplexer output,
the second multiplexer arranged to connect either the third multiplexer input or the fourth multiplexer input to the second multiplexer output,
wherein the third multiplexer input is arranged to receive signal from a first input event channel and the fourth multiplexer input is arranged to receive signal from a second input event channel, and the output of the second multiplexer is provided to the input event channel.

According to an embodiment of the invention the event stream manipulation apparatus where the input events received from the input event channel correspond to constant time intervals.

According to an embodiment of the invention the event stream manipulation apparatus where integer event signal representation is ternary.

According to an embodiment of the invention an event stream manipulation system comprises at least two event stream manipulation apparatuses, wherein the output event channel of event stream manipulation apparatus is connected to the input event channel of the event stream manipulation apparatus.

According to an embodiment of the invention an event stream manipulation system comprises at least two event stream manipulation apparatuses, wherein a first event source arranges data to the input event channel of event stream manipulation apparatus and a second event source arranges data to the input event channel of event stream manipulation apparatus.

According to an embodiment of the invention an event stream manipulation system where the events provided at output event channels of event stream manipulation apparatuses, or events provided by input event channels are received by an event processing unit and used for image analysis.

According to an embodiment of the invention an event stream manipulation system comprises:
a third event stream manipulation apparatus, wherein a third event source arranges data to the input event channel of event stream manipulation apparatus,
event stream manipulation apparatus provides events to an output event channel and the output event channel is received by event processing unit, or events on the input event channel are received by event processing unit,
the image analysis carried out by the event processing unit is optical flow evaluation.

### BRIEF DESCRIPTION OF THE DRAWINGS

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

FIG. 1 illustrates a process flow for generating slower sampled rate event stream from faster event stream,

FIG. 2 illustrates an event generation apparatus according to a first embodiment of the invention,

FIG. 3 illustrates an event generation apparatus with an event preprocessing circuit,

FIG. 4 illustrates an event generation apparatus with a second digital memory and a first multiplexer,

FIG. 5 illustrates an event generation apparatus with an input channel selector,

FIG. 6 illustrates a variant of an event generation circuit with an input channel selector,

FIG. 7 illustrates an event generation system with multiple event generation circuits,

FIG. 8 illustrates an event generation system with multiple event generation circuits and multiple event sources accompanied by an event processing unit,

FIG. 9 illustrates how the event generation system of FIG. 8 could be used for optical flow computation.

### DETAILED DESCRIPTION OF THE PREFERRED EMBODIMENTS OF THE INVENTION

In order to provide event stream manipulation that generates event streams corresponding to slower timescales from an input event stream, new means to process and store event signals is introduced in this disclosure.

Define event source as apparatus that generates events E(i), where i=0, 1, 2, . . . Events are updated in essentially synchronous manner and take values from a discrete set of [−N,M], where the integer N is a minimum magnitude of the event and M is a maximum magnitude of the event. In most practical cases N and M are equal in their absolute value, and the rest of the description is based on the case, where abs(N)=abs(M). For clarity, the term integer event is used throughout this patent application as a synonym to quantized magnitude events. Examples of such event value sets are {−1,0,1}, {−2,−1,0,1,2} and {−7,−6,−5,−4,−3,−2,−1,0,1,2,3,4,5,6,7}. The representation of the discrete event values can vary, where simple examples are digital number representation, or every nonzero event value can form its own binary valued event channel. For example, the ternary event can be represented by two separate {0, 1} valued channels, one channel for +1 and the other channel for −1 channel. The presence of value 1 in a particular channel represents the nonzero value of the event. In multi channel representation it is obvious that only one channel can be nonzero at each time instant.

One way to illustrate an event stream is to monitor a sensor signal, and with constant intervals record the integer value of how much the sensor signal has changed between consecutive sampling instants. The resulting time series of changes in the signal correspondingly forms an event stream that would be the output of an event source. One example is to form event streams from each pixel in a pixel array. On the other hand, an event stream could be considered as more abstract, without a direct link to for example a sensor signal; another example of event source could be a memory that outputs an event stream.

From the event stream E(i) it is possible to generate half-rate events F(j), where j=0, 1, 2, . . . for each odd i by the rules
j=(i−1)/2
F(j)=clamp(E(i−1)+E(i)), where clamp is a function that limits the output between −M and M:

$$clamp ( x ) = \{ \begin{matrix}- M , & if x < - M \\ M , & if x > M \\ x , & otherwise\end{matrix}$$

Alternatively (in the following this is called even indexing), it is possible to generate half-rate events F(j), where j=0, 1, 2, . . . for each even i by the rules
j=i/2
F(j)=clamp(E(i−1)+E(i))

Half-rate events can be used to generate quarter-rate events in a similar fashion.

In general, let E₀(i₀) be the source events. One can generate arbitrarily many streams of slower-rate events E₁(i₁), E₂(i₂), E₃(i₃), . . . Eₖ(iₖ) by applying the above rule recursively: Generate events Eₖ(iₖ) where iₖ=0, 1, 2, . . . by the rules
iₖ=(iₖ₋₁−1)/2 [or with even indexing: iₖ=iₖ₋₁/2]
Eₖ(iₖ)=clamp(Eₖ₋₁ (iₖ₋₁−1)+Eₖ₋₁ (iₖ₋₁)), where clamp is a function that limits the output between −M and M

Application of these rules can be arranged so that at most one rule is applied per timestep i₀ (here a timestep is marked by strikethrough if two values of previous level events are not yet available in this series):
1. Compute E₁ [symbol]
3. Compute E₁ [symbol]
5. Compute E₁
6. Compute E₂
7. Compute E₁ [symbol]
9. Compute E₁
10. Compute E₂
11. Compute E₁
12. Compute E₃
13. Compute E₁
14. Compute E₂
15. Compute E₁ [symbol]
17. Compute E₁
18. Compute E₂
19. Compute E₁
20. Compute E₃
21. Compute E₁
22. Compute E₂
23. Compute E₁
24. Compute E₄
25. . . . .

The above series is acquired by the following rule: at timestep T compute E₅ from two previous values of Eₛ₋₁, where s satisfies the equation

T=2^{s-1} mod(2^{s}).

Notice that other rules guaranteeing the same condition (at most one rule is applied per timestep) exist, the above is an example of such a rule. It should also be noticed, that by applying the above rule, some of the computations produce results with a certain latency to their ‘expected’ actual time stamping. However, the longer latencies are more concentrated to slower time scales, where typically latencies can be better tolerated. It is also possible to compute multiple time scales at each time stamp by increasing parallelism in the evaluation, whereas the interleaving operation guarantees more steady resource utilization.

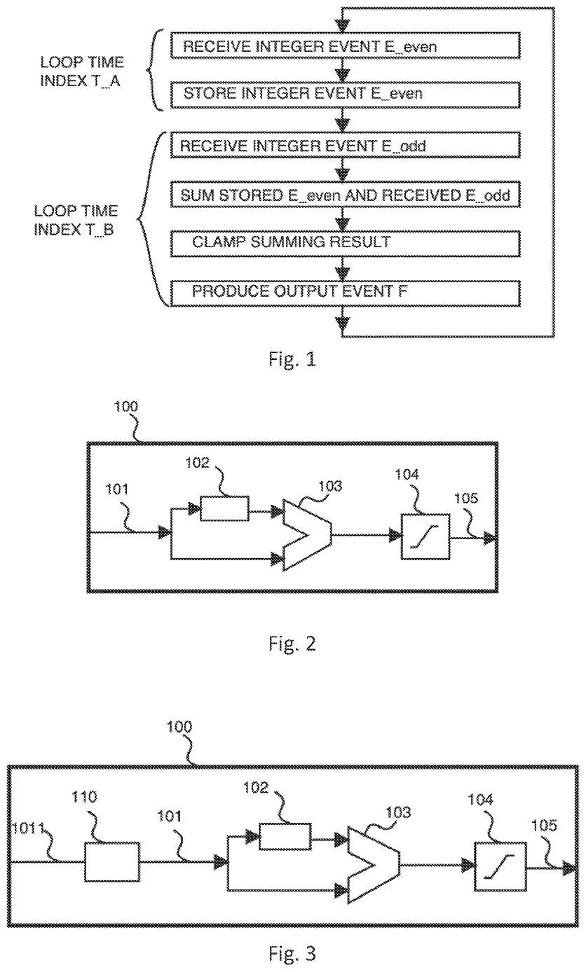

The generation of the slower event takes a period of two time stamps. The process of generating the slower event representation from two faster ones is shown in FIG. 1 with time labels T_A for first time stamp instant and T_B for the second time stamp instant. During the time stamp T_A an event is received and then stored for later utilization. For clarity, in FIG. 1, the first event is marked as an even event, referring to global indexing process of events described above. However, the first received event could also be an odd event and the second received event would then be an even event. It is obvious that the procedures labeled under either time instance need not occur simultaneously, but can be performed one after the other in the order shown in FIG. 1. Executing operations in series in time introduce some latency, where the latency is typically very small as compared to the event frequencies. During time stamp instant T_B first, an odd event is received to the apparatus and then the event stored during T_A is added together with the event received during T_B. The addition result is further clamped according to the clamping rule introduced earlier in the text. Finally, during the time stamp instant T_B, the result of the clamping is provided as the output of the event generation process. After all the processes for T_B have been executed, the process rolls back to T_A for receiving the next event.

FIG. 2 illustrates an event generation apparatus (100) according to a first embodiment of the invention. The event generation circuit (100) receives input events from input event channel (101) that is driven by an event source. The event generation works so that
input event channel (101) is arranged to provide a first integer event signal corresponding to a time instant T_A and first digital memory (102) is arranged to receive and store the first integer event
and a second integer event signal corresponding to a time instant T_B is arranged to input event channel (101)
summing circuit (103) receives first integer event signal and second integer input signal as inputs and produces a first summing result; the first summing result is arranged to the output of the summing circuit (103)
the output of summing circuit (103) is received by an event clamping circuit (104) and arranged to determine whether the summing result is above or equal to a positive threshold and in such case produce a first output event that equals the positive threshold, or to determine whether the summing result is below a negative threshold and in such case produce a first output event that equals the negative threshold, or to determine whether the summing result is below the positive threshold and above the negative threshold and in such case produce a first output event that equals the summing result, wherein the result event corresponding to time instant T_B is arranged to the output event channel (105) at the output of the event stream apparatus (100). The result event is essentially a half-rate event, i.e., events appear at the input channel at twice the rate as they are provided to the output event channel.

After this, the event generation apparatus can receive the next two input events and produce a second output (half-rate) event.

FIG. 3 illustrates that the event generation apparatus (100) can receive an input event stream (101) from a preprocessing circuit (110).
The preprocessing circuit (110) receives raw input event stream (1011) from an event source
The preprocessing circuit (110) provides an output signal that is a function of at least one raw input event. For example, the output of the preprocessing circuit (110) could be a linear or nonlinear function of a raw input event.

In another embodiment of the invention the preprocessing circuit (110) could provide an output event that is a function of multiple raw input events.
For example, the preprocessing circuit could calculate a convolution operation for the stream of raw input events; as an example, the convolution could take three consecutive raw input events to produce an output event. In the case of convolution, the rate of output events from the preprocessing circuit would equal the rate of raw input events entering the preprocessing circuit.

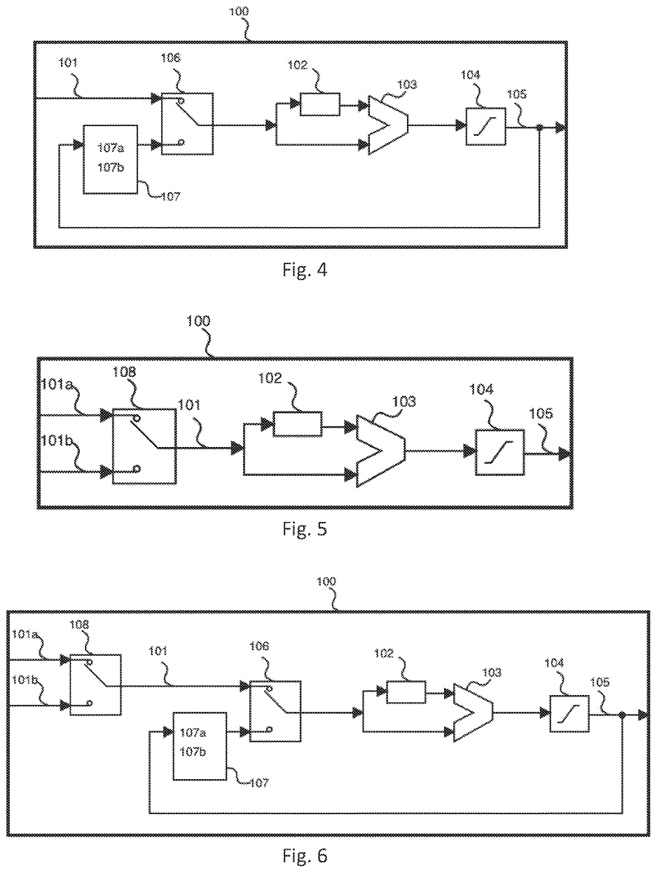

FIG. 4 illustrates an event stream manipulation apparatus (100) that additionally comprises
a first multiplexer (106) having a first multiplexer input and a second multiplexer input and a first multiplexer output, the first multiplexer arranged to connect either the first multiplexer input or the second multiplexer input to the first multiplexer output, wherein the first multiplexer input is arranged to receive signal from the input event channel (101) and the second multiplexer input is arranged to receive signal from a second digital memory (107), and the first multiplexer output (106) is provided to the first digital memory (102) and the second summing input of the summing circuit (103)
a second digital memory (107) with at least one memory location.
In FIG. 4 digital memory with two memory locations is shown (107a, 107b) arranged to receive and store a signal from the output event channel (105) and arranged to provide an output signal to the second multiplexer input

The event stream manipulation apparatus illustrated in FIG. 4 is capable of reusing the summing circuit and clamp circuit so that it can be used to generate half-rate events and quarter-rate events. The method of using the event stream manipulation apparatus of FIG. 4 is described in the exemplary description below
arrange the multiplexer (106) to pass input event stream (101) to the output of the multiplexer,
calculate first half rate event from first integer signal event and second integer signal event similarly to what was described in the above explanation of FIG. 2,
Store the first half rate event to memory location (107a) in second digital memory (107),
Similarly calculate the second half rate event with the next two events received from the input event channel (101), and store the second half rate event to memory location (107b) in the second digital memory,
Arrange the multiplexer (106) to pass the output of the second digital memory to the input of the first digital memory (102) and to the second input of the summing circuit (103),
arrange the first half-rate event stored in memory location (107a) to the output of the second digital memory and write it to the first digital memory (102),
Arrange the second half-rate event stored in memory location (107b) to the output of the second digital memory and arrange it the second input of the summing circuit,
obtain first quarter-rate event from the output event channel (105).

The event stream manipulation apparatus illustrated in FIG. 4 can produce increasingly slow rate events, for example octal-rate events (half the rate of quarter-rate events) from quarter-rate events, provided that more memory locations are added to the second digital memory. Furthermore, the second digital memory can be accompanied by a second event proprocessing circuit that would be used to preprocess the slower-rate events.

FIG. 5 and FIG. 6 illustrate an event stream manipulation apparatus (100) that further comprises
a second multiplexer (108) having a third multiplexer input and a fourth multiplexer input and a second multiplexer output, the second multiplexer arranged to connect either the third multiplexer input or the fourth multiplexer input to the second multiplexer output, wherein the third multiplexer input is arranged to receive signal from a first input event channel (101a) and the fourth multiplexer input is arranged to receive signal from a second input event channel (101b), and the output of the second multiplexer (108) is provided to the input event channel (101)

The second multiplexer receives data from two input event streams (101a, 101b) that are provided by a first event source and a second event source. For example, the first and second event sources could be image sensor circuits on the same pixel column that provide event data to a shared event stream manipulation apparatus (100).

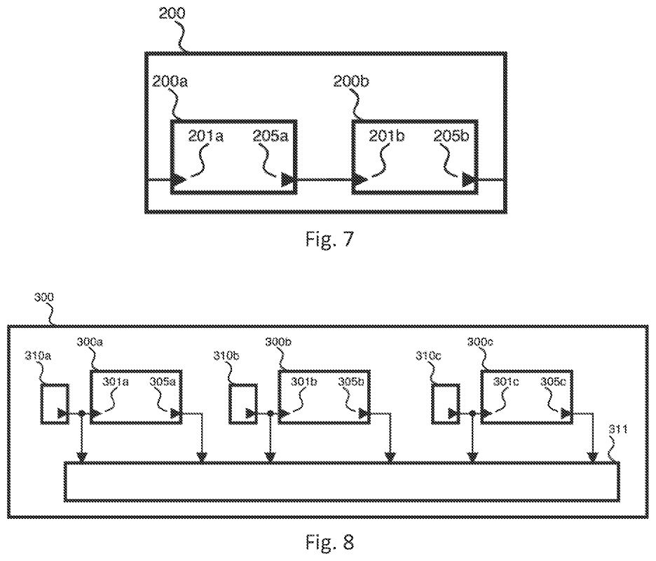

FIG. 7 illustrates an event stream manipulation system (200), that comprises at least two event stream manipulation apparatuses (200a,200b), wherein the output event channel (205a) of event stream manipulation apparatus (200a) is connected to the input event channel (201b) of the event stream manipulation apparatus (200b). This way the event stream manipulation apparatus (200a) receives full-rate events and produces half-rate events at the output event channel (205a), whereas event stream manipulation apparatus (200b) receives half-rate events and produces quarter-rate events at the output of the event channel (205b). By increasing the number cascaded event stream manipulation apparatuses, increasingly slow rate events can be produced. The arrangement of FIG. 7 can be seen to produce similar results with less latency to that of FIG. 4, wherein the apparatus in FIG. 4 achieves the same result with a better resource utilization by feeding the output event back to the input.

FIG. 8 illustrates an event stream manipulation system (300), comprising at least two event stream manipulation apparatuses (300a,300b).
The first event source (310a) arranges data to the input event channel (301a) of event stream manipulation apparatus (300a) and a second event source (310b) arranges data to the input event channel (301b) of event stream manipulation apparatus (300b)

The event stream manipulation system (300) may comprise an event processing unit (311) as illustrated in FIG. 8:
the events provided at output event channels (305a, 305b) of event stream manipulation apparatuses (300a, 300b), or events provided by input event channels (301a, 301b) are received by an event processing unit (311)
if the event sources (310a and 310b) provide event data from an image sensor, the event processing unit (311) can be used for image analysis.

An example of event analysis that event processing unit (311) could do is optical flow evaluation. In this case event stream manipulation apparatuses (300a, 300b, 300c) would provide output event streams to output event channels (305a, 305b, 305c) and the event processing unit (311) would receive and use these data for optical flow computation. Alternatively, event data from input data streams (301a, 301b, 301c) could be used for optical flow computation. The event-based optical flow computation is explained below in more detail.

For a Rolling Shutter mode, the slower event frames can be generated in a row by row manner for the new evaluated pixel locations and once the updated pixel neighborhood for the events has been sufficiently updated, the pixel event neighborhood can be analyzed also in a row by row manner resulting in efficient pipeline processing. One of the processing possibilities for the event frame, and utilizing the pixel local neighborhood, is optical flow computation.
In a typical pixel array, together forming a 2D imager array, each pixel can be considered as an individual sensor producing individually an event stream, and therefore each pixel could operate with their unique time interval for the event update. However, in practice it is convenient to scan multiple sensors simultaneously thus generating correspondence between their time stamps.
Typically in image sensors, the scanning takes place in a row by row manner (Rolling Shutter) yielding a concept of Row Time Instant for each pixel on the same row. Alternatively all the pixels can be evaluated regularly at certain time instants (Global Shutter). Although the Global Shutter mode would be preferable for sampling uniformity (yielding to coherent Frame Time Instant) within the image area, a fast enough Rolling Shutter mode emulates the Global Shutter mode locally for each individual pixel and the event results from the neighboring rows can be assumed to belong to the essentially same Time Instant opening up the possibility to do arithmetic and pattern matching within the pixel neighborhood for events produced essentially during the same time stamp.
Whereas in the Global Shutter Mode it is obvious, that each frame has a unique and pixel-uniform time stamp, in the Rolling Shutter mode with the assumption of small time difference between the scanned rows, a pseudo-uniform time stamp can be attached to each frame. The pseudo time stamp is changing, when the scanning of the row moves from one end of the imager to the other end and where the concept of scanning the neighbor row is broken.

Let us consider one of the above defined event streams E(i) (this can be the original stream of source events, or any stream of the slower-rate events). Furthermore, let us assume that the event-stream is three-dimensional with one time dimension and two spatial dimensions E(i,x,y). Such an event stream could be obtained from an event camera with synchronous event generation. Optical flow events O(i,x,y) can be obtained from two successive event frames E(i,x,y) and E(i−1,x,y) as follows.

In the following, we assume that M=1 (so that the event values are from the set {−1,0,1}): if in the original event stream M>1, consider the sign of the events instead of the events.

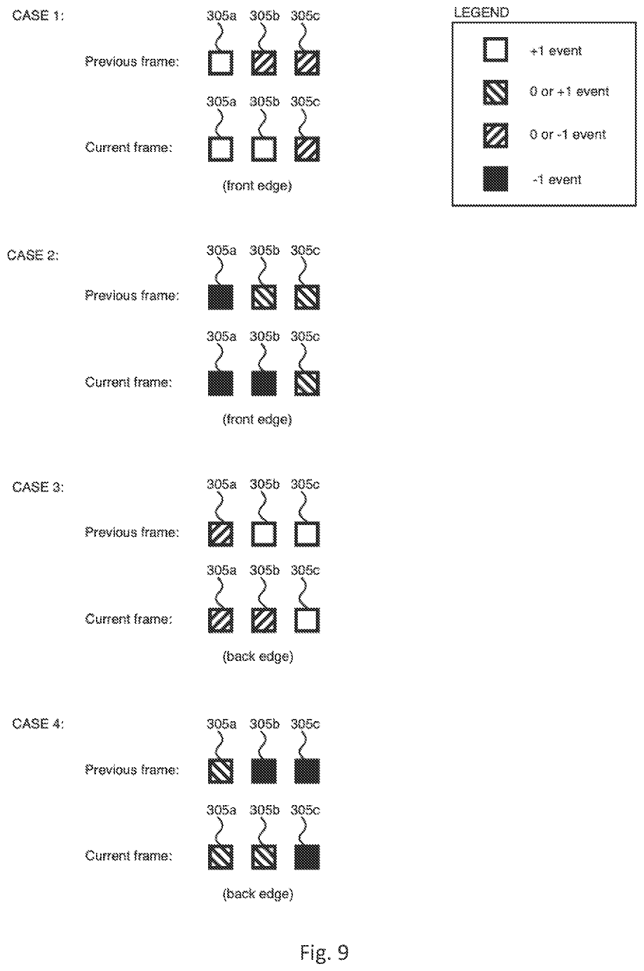

Motion towards right is at position (x,y) if the nearest horizontal neighborhood at (x,y) satisfies one of the following four cases shown in FIG. 9. The Case 1 monitors whether there was a positive event in the previous frame on the left side pixel, but no positive event in the pixel location, and that at the current frame there still is a positive event in the left neighbor, but in this frame, also there is a positive event at the pixel location (x,y). This type of occurrence is easy to monitor with simple hardware, especially, when the events are ternary and possibly even presented by two different channels, one for positive events and one for negative events. In Case 1 the moving front is brighter than the background it is moving to. Case 2 presents object front movement, where the object is darker than the background. Case 3 presents a darker than background movement for the object back (i.e. the background is exposed behind the object due to the object moving away from blocking the background). Case 4 presents a brighter object back front detection condition.

Using similar rules, one can detect motion towards left, up or down. This results in an optical flow event with 8 possible directions (N, NE, E, SE, S, SW, W, NW).

It is obvious, that there exist also other types of refined information one can obtain from the event stream and the optical flow is just one illustrative example of the information extraction possibilities.

Being computer-related, it can be appreciated that the components disclosed herein may be implemented in hardware, software, or a combination of hardware and software. Software components may be in the form of computer-readable program code stored in a computer-readable storage medium such as memory, mass storage device, or removable storage device. For example, a computer-readable medium may comprise computer-readable code for performing the function of a particular component. Likewise, computer memory may be configured to include one or more components, which may then be executed by a processor. Components may be implemented separately in multiple modules or together in a single module.

Only advantageous exemplary embodiments of the invention are described in the figures. It is clear to a person skilled in the art that the invention is not restricted only to the examples presented above, but the invention may vary within the limits of the claims presented hereafter. Some possible embodiments of the invention are described in the dependent claims, and they are not to be considered to restrict the scope of protection of the invention as such.

1. An event stream manipulation apparatus (100) comprising
An input event channel (101) arranged to receive events from a synchronously scanned sensor event source to provide a first integer event signal corresponding to a time instant T_A and a second integer event signal corresponding to a time instant T_B, wherein time instant T_A precedes time instant T_B
characterized in that the event stream manipulation apparatus (100) comprises:
a first multiplexer (106) having a first multiplexer input and a second multiplexer input and a first multiplexer output, the first multiplexer arranged to provide either the first multiplexer input or the second multiplexer input to the first multiplexer output, wherein
the first multiplexer input is arranged to receive signal from the input event channel (101),
the second multiplexer input is arranged to receive signal from a second digital memory (107),
the first multiplexer output (106) provides a third integer event signal and arranges the third integer event signal to a first digital memory (102) and the second summing input of a summing circuit (103),
a first digital memory (102) arranged to receive and store the third integer event signal from the first multiplexer (106) and arrange a fourth integer event signal at the output of the first digital memory,
a summing circuit (103) having a first summing input and a second summing input, wherein
the first summing input is arranged to receive the fourth integer event signal from the first digital memory (102),
the second summing input is arranged to receive the third integer event signal from the first multiplexer (106),
the summing circuit (103) is arranged to sum the third integer event signal with the fourth integer event signal and to produce a first summing result, wherein the first summing result is provided to the output of the summing circuit (103),
an event clamping circuit (104) connected to the summing circuit (103) and arranged to receive the first summing result
and to determine whether the first summing result is above or equal to a positive threshold and in such case produce a first output event that equals the positive threshold,
and to determine whether the first summing result is below or equal to a negative threshold and in such case produce a first output event that equals the negative threshold,
and to determine whether the first summing result is below the positive threshold and above the negative threshold and in such case produce a first output event that equals the first summing result,
wherein the first output event is arranged to the output event channel (105) at the output of the event stream apparatus (100),
a second digital memory (107) with at least two memory locations (107a, 107b) arranged to receive and store the first output event at two different time instants, and arranged to provide the events stored at memory locations (107a, 107b) to the second multiplexer input.

2. The event stream manipulation apparatus (100) according to claim 1 characterized in that the sensor event generation circuit (100) comprises:
an event preprocessing circuit (110) arranged to receive at least one raw input event signal from raw input event channel (1011) and arranged to provide an output signal that is a function of at least one raw input event signal, wherein the output signal of the event preprocessing circuit (110) is arranged to the input event channel (101).

3. The event stream manipulation apparatus (100) according to any of the preceding claims characterized in that the sensor event generation circuit (100) comprises:
a second multiplexer (108) having a third multiplexer input and a fourth multiplexer input and a second multiplexer output,
the second multiplexer arranged to connect either the third multiplexer input or the fourth multiplexer input to the second multiplexer output,
wherein the third multiplexer input is arranged to receive signal from a first input event channel (101a) and the fourth multiplexer input is arranged to receive signal from a second input event channel (101b), and the output of the second multiplexer (108) is provided to the input event channel (101).

4. The event stream manipulation apparatus according to any of the preceding claims, characterized in that where the integer event signals received from the input event channel (101) correspond to constant time intervals.

5. The event stream manipulation apparatus according to any of the preceeding claims, characterized in that integer event signal representation is ternary.

6. An event stream manipulation system (200), characterized in that the event stream manipulation system comprises at least a first event stream manipulation apparatus (200a) and a second event stream manipulation apparatus (200b) according to any of the preceding claims, wherein the output event channel (205a) of the first event stream manipulation apparatus (200a) is connected to the input event channel (201b) of the second event stream manipulation apparatus (200b).

7. An event stream manipulation system (300), characterized in that the event stream manipulation system comprises at least a first event stream manipulation apparatus (300a) and a second event stream manipulation apparatus (300b) according to any of claims 1, 2, 3, 4 or 5, wherein a first event source (310a) arranges data to the input event channel (301a) of the first event stream manipulation apparatus (300a) and a second event source (310b) arranges data to the input event channel (301b) of the second event stream manipulation apparatus (300b).

8. An event stream manipulation system (300) according to claim 7, characterized in that the events provided at output event channels (305a, 305b) of the first and the second event stream manipulation apparatuses (300a, 300b), or events provided by the input event channels (301a, 301b) of the first and the second event stream manipulation apparatuses (300a, 300b) are received by an event processing unit (311) and used for image analysis.

9. An event stream manipulation system according to claim 8, characterized in that the event stream manipulation apparatus (300) comprises:
A third event stream manipulation apparatus (300c) according to any of claims 1, 2, 3, 4 or 5, wherein a third event source (310c) arranges data to the input event channel (301c) of the third event stream manipulation apparatus (300c),
the third event stream manipulation apparatus (300c) provides events to an output event channel (305c) and the events on the output event channel (305c) is received by an event processing unit (311), or events on the input event channel of the third event stream manipulation apparatus (300c) are received by an event processing unit (311),
the image analysis carried out by the event processing unit (311) is optical flow evaluation.
